(19) United States
(12) Patent Application Publication
(10) Pub. No.: US 2008/0045397 A1
(43) Pub. Date: Feb. 21, 2008

(54) Noble metal alkali borosilicate glass composition

(76) Inventor: Pedro M. Buarque de Macedo, Bethesda, MD (US)

Correspondence Address: AMSTER, ROTHSTEIN & EBENSTEIN LLP, 90 PARK AVENUE, NEW YORK, NY, 10016, US

(21) Appl. No.: 11/893,151

(22) Filed: Aug. 14, 2007

Related U.S. Application Data
(63) Continuation-in-part of application No. 11/504,953, filed on Aug. 16, 2006.

(51) Int. Cl. C03C 3/091

(52) U.S. Cl. 501/66

(57) ABSTRACT

An embodiment of the present invention comprises a ceramic catalyst comprising a porous ceramic/silica glass substrate having substantially interconnecting pores with an average pore size of approximately 2 micron or less and particles comprising one or more noble metals on the surface of the substantially interconnecting pores. The noble metal particles may be either amorphous and/or crystalline nano-particles. The noble metals preferably may comprise silver, gold, rhodium, and/or palladium. The average pore size may be approximately 1 micron or less, 0.5 microns or less, 0.3 microns or less, 0.2 microns or less, 100 nanometers or less, 50 nanometers or less, or between 50 nanometers and 150 nanometers. Other embodiments of the present invention are directed to methods of manufacturing the ceramic catalyst and novel glass compositions used to manufacture the ceramic catalyst and using the ceramic catalyst at temperatures above 200° C. to produce hydrogen gas and to store hydrogen gas.

### CROSS-REFERENCE TO RELATED APPLICATION

This patent application is a continuation-in-part of co-pending U.S. patent application Ser. No. 11/504,953, filed on Aug. 16, 2006 and entitled “Ceramic Catalysts,” the entire content of which is incorporated herein by reference.

### FIELD OF INVENTION

The present invention relates generally to a ceramic catalyst and a method of manufacturing the same. The present invention also generally relates to novel glass compositions and to glass articles particularly suitable for forming or being converted to ceramic catalyst.

### BACKGROUND OF THE INVENTION

Ceramic catalysts are commonly used to expedite gas phase chemical reactions, such as completing the oxidation of the exhaust fumes from a combustion engine. Unfortunately, prior art catalysts have limited effectiveness for high processing rate applications because they have a relatively low surface-area-to-volume ratio. The catalyst in accordance with the present invention involves a ceramic matrix that immobilizes amorphous or crystalline noble metal nano-particles. As the organic chemicals pass through the ceramic, the organic molecules attach to the noble metal, catalyzing a reaction. Such attachment increases the reaction rate, and the resulting product molecules leave the noble metal.

The present invention can be used to address the problem with U.S. Pat. No. 7,186,396 B2 to Ratner et al. U.S. Pat. No. 7,186,396, the contents of which are hereby incorporated by reference in their entirety, discloses an efficient method to store and transport hydrogen “gas” by attaching the hydrogen atoms to organothiol compounds which can be stored at atmospheric pressure at room temperature. This can be compared to the method of storing hydrogen gas at atmospheric pressure, requiring extremely low temperatures (very expensive), or storing hydrogen gas at room temperature, requiring extremely high pressures (also very expensive). The method of using organothiol compounds disclosed in U.S. Pat. No. 7,186,396 provides a much cheaper way to transport the hydrogen, thus opening the hydrogen economy. However, the problem with the method disclosed by U.S. Pat. No. 7,185,396 is that it does not have an efficient catalyst to detach the hydrogen from the organothiol so that the hydrogen can be used to generate energy, and attach to the depleted organothiol molecules at the hydrogen source.

It is an object of the present invention is to increase the efficiency of the ceramic catalyst while minimizing the cost.

It is also an object of the present invention to increase the surface area of the exposed catalyst metal in a given volume.

It is also an object of the present invention to make an efficient high temperature ceramic catalyst.

It is also an object of the present invention to use an efficient high temperature ceramic catalyst to perform more efficient chemical reactions, preferably in conjunction with the technology disclosed in U.S. Pat. No. 7,186,396 B2.

These and other objects and advantages of the present invention will become apparent from the following description.

### BRIEF DESCRIPTION OF THE DRAWINGS

The above and related objects, features and advantages of the present invention will be more fully understood by reference to the following, detailed description of the preferred, albeit illustrative, embodiments of the present invention when taken in conjunction with the accompanying figures, wherein:

FIG. 1 shows the pores of ceramic glass substrate prepared in accordance with one possible embodiment of the present invention.

FIG. 2 shows the noble metals in the ceramic catalyst made in accordance with one possible embodiment of the present invention.

### SUMMARY OF THE INVENTION

It has now been found that the above and related objects of the present invention are obtained in the form of a ceramic catalyst having interconnecting pores partially stuffed with amorphous and/or crystalline nano-particles comprising one or more noble metals on the surface of the interconnecting pores.

One embodiment of the present invention is a ceramic catalyst for use at a high temperature comprising a porous ceramic/silica glass substrate having substantially interconnecting pores with an average pore size of approximately 2 microns or less and particles comprising one or more noble metals on the surface of the substantially interconnecting pores. Preferably, the catalyst can operate at the temperature of 200° C. or more, 250° C. or more, 300° C. or more, or 350° C. or more. The particles may be amorphous and/or crystalline nano-particles. The noble metals may preferably comprise silver, gold, rhodium and/or palladium. The porous ceramic/silica can be made by many methods including: phase-separated leached glass; and silica gel, made by solution chemistry or plasma precipitation.

The porous ceramic/silica substrate has an average pore size preferably of approximately 2 microns or less, preferably of approximately 1 micron or less, preferably of approximately 0.5 microns or less, preferably of approximately 0.3 microns or less, preferably of approximately 0.2 microns or less, preferably of approximately 100 nanometers or less, preferably of approximately 50 nanometers or less, or between 50 nanometers and 150 nanometers.

The size of the porous ceramic/silica glass substrate is preferably 40 mesh (0.420 mm) or less, preferably between 40 mesh (0.420 mm) and 100 mesh (0.149 mm), preferably between 100 mesh (0.149 mm) and 200 mesh (0.074 mm), preferably between 200 mesh (0.074 mm) and 325 mesh (0.044 mm), or preferably less than 325 mesh (0.044 mm).

The average size of each of the noble metal particles is preferably 1.0 micron or less, preferably 0.5 microns or less, preferably 200 nanometers or less, preferably 100 nanometers or less, or preferably 50 nanometers or less.

The concentration of noble metals in the catalyst is given in Table A below, which relates molar concentrations of noble metals in aqueous solution to weight % of noble metal(s) per gram of porous glass. Preferably, there may be at least 1 weight % of noble metal(s) or more, preferably at least 2 weight %, or preferably at least 5 weight % in the ceramic catalyst.

TABLE A
CALCULATION OF WEIGHT PERCENT OF NOBLE METAL(S)
IN THE POROUS GLASS

| Molar concentration of | | | | | | |
|---|---|---|---|---|---|---|
| noble metal in solution used | | | | | | |
| to load the ceramic pores | | 0.1 | 0.2 | 0.5 | 1 | 1.5 |
| Noble Metal | Atomic Mass | Wt % | Wt % | Wt % | Wt % | Wt % |
| Ag | 109 | 0.43 | 0.85 | 2.13 | 4.27 | 6.40 |
| Au | 197 | 0.77 | 1.54 | 3.85 | 7.71 | 11.56 |
| Rh | 103 | 0.40 | 0.81 | 2.02 | 4.03 | 6.05 |
| Pd | 106 | 0.41 | 0.83 | 2.07 | 4.15 | 6.22 |

Note:
The percentage is the ratio of the mass of noble metals divided by the mass of the porous glass
The porous ceramic/silica glass density prior to the addition of noble metals is approximately between 1.1 g/cm³ and 1.2 g/cm³, averaging 1.15 g/cm³
The porous ceramic/silica glass pore volume prior to adding noble metals is approximately between 40% and 50%, averaging 45%

The porous ceramic/silica glass density prior to the addition of noble metals is approximately between 1.1 g/cm³ and 1.2 g/cm³, averaging 1.15 g/cm³
The porous ceramic/silica glass pore volume prior to adding noble metals is approximately between 40% and 50%, averaging 45%

The concentration of the noble metals in the substantially interconnecting pores is equivalent to preferably 0.1 molar solution or greater, preferably 0.2 molar solution or greater, preferably 0.5 molar solution or greater, preferably 1.0 molar solution or greater, or preferably 1.5 molar solution or greater.

The concentration of a non-noble metal is smaller than the concentration of the noble metal in the substantially interconnecting pores in the catalyst, wherein the non-noble metal may be iron, tin, nickel, chromium, cobalt, zinc, or manganese, which may catalyze undesirable reaction. The concentration of the non-noble metal in the substantially interconnecting pores in the catalyst is preferably less than approximately 10% of the concentration of the noble metals in the substantially interconnecting pores, or more preferably less than approximately 1% of the concentration of the noble metals in the substantially interconnecting pores.

In another embodiment of the present invention, the noble metal particles are coated with a different noble metal. In this embodiment, the first noble metal may preferably be silver and the second noble metal may preferably be gold, rhodium, and/or palladium.

Yet another embodiment of the present invention is a noble metal alkali borosilicate glass with the following composition range in mole percent: 48-64 SiO₂, 28-42 B₂O₃, 4-9 R₂O, 0-3 Al₂O₃, and 1-4 MₓO_{y}, wherein R refers to one or more alkali metals, M refers one or more noble metals, x varies between approximately 1 and approximately 2, and y varies between approximately 1 and approximately 2. The alkali metals R may be one or more of the following alkali metals: lithium, sodium, potassium, rubidium and cesium. The noble metals M may preferably comprise one or more of the following noble metals: silver, rhodium, and/or palladium. In the case where M is silver, x is approximately 2 and y is approximately 1. In the case where M is rhodium, x and y are approximately 1 and 2, respectively. In the case where M is palladium, x and y are approximately 1.

Yet another embodiment of the present invention is a noble metal alkali borosilicate glass with the following composition range in mole percent: 49.5-59 SiO₂, 33-37 B₂O₃, 5-8 R₂O, 0-2 Al₂O₃, and 1.5-2.5 MₓO_{y}, wherein R refers to one or more alkali metals, M refers one or more noble metals, x varies between approximately 1 and approximately 2, and y varies between approximately 1 and approximately 2. The alkali metals R may be one or more of the following alkali metals: lithium, sodium, potassium, rubidium and cesium. The noble metals M may preferably comprise one or more of the following noble metals: silver, rhodium, and/or palladium. In the case where M is silver, x is approximately 2 and y is approximately 1.

The present invention is also directed to a ceramic catalyst comprising a borosilicate glass substrate having substantially interconnecting pores with an average pore size of approximately 1 micron or less, and particles comprising one or more noble metals on the surface of the substantially interconnecting pores. The particles in the catalyst may comprise colloids, or nanocrystals, or a combination of colloids and nanocrystals. The one or more noble metals in the catalyst may comprise silver, gold, rhodium, or palladium. Alternatively, the one or more noble metals may comprise silver and gold. Alternatively, the one or more noble metals may comprise silver and the particles may be coated with a layer of a second noble metal on a surface of the particles, wherein the second noble metal is gold, rhodium, or palladium. The average pore size is preferably approximately 0.5 microns or less, preferably approximately 0.3 microns or less, or preferably approximately 0.2 microns or less.

The present invention is also directed to a noble metal alkali borosilicate glass composition comprising approximately 48-64 mole % SiO₂, 28-42 mole % B₂O₃, 4-9 mole % R₂O, 0-3 mole % Al₂O₃, and 1-4 mole % MₓO_{y}, wherein R is one or more alkali metals, M is one or more noble metals, x varies between approximately 1 and approximately 2, and y varies between approximately 1 and approximately 5. M may comprise gold, silver or rhodium. Alternatively, M may comprise gold and silver, x is approximately 2 and y is approximately 1.

The present invention is also directed to a noble metal alkali borosilicate glass composition comprising approximately 49.5-59 mole % SiO₂, 33-37 mole % B₂O₃, 5-8 mole % R₂O, 0-2 mole % Al₂O₃, and 1.5-2.5 mole % MₓO_{y}, wherein R is one or more alkali metals, M is one or more noble metals, x varies between approximately 1 and approximately 2 and y varies between approximately 1 and approximately 5. M may comprise gold, silver, rhodium, or palladium. Alternatively, M comprises gold and silver, x is approximately 2 and y is approximately 1. Alternatively, M comprises rhodium and x and y are approximately 1.

The present invention is also directed to a noble metal alkali borosilicate glass composition comprising approximately 56 mole % SiO₂, 36 mole % B₂O₃, 3 mole % Na₂O, 3 mole % K₂O, 2 mole % Ag₂O.

Yet another embodiment of the present invention is a method of manufacturing a ceramic catalyst comprising the following steps:
a) providing raw materials to form a noble metal alkali borosilicate glass;
b) heating the raw materials at approximately 1,200° C. to 1,500° C. to form a melt (viscous solution) and stirring the melt;
c) cooling the melt without phase separation occurring;
d) heat treating the cooled melt for approximately 0.5-24 hours at approximately 500° C. to 650° C. such that it separates into two phase—a silica rich phase and a silica poor phase—the latter containing most of the noble metal such as silver, if any was added to the raw materials;
e) cooling the phase-separated material to approximately a room temperature, at which time the melt has become a glass;
f) leaching the silica poor phase of the glass to form substantially interconnecting pores due to the conditions of prior heat treatment under Step (d);
g) leaching the silica poor phase of the glass with a leaching agent to form substantially interconnecting pores in the glass so that at least a portion of the noble metal remains on the surface of the interconnecting pores, wherein the leaching agent is not a solvent for the noble metal; and
h) drying the glass.

In one embodiment of this method of manufacturing a ceramic catalyst, the noble metal may be silver. The raw materials may be silver nitrate and/or silver chloride. The method of reducing the noble metal(s) may also comprise the step of exposing the glass to UV light. The method may also include the step of grinding and sieving the glass prior to leaching.

Yet another embodiment of the present invention comprises a method of making a ceramic catalyst using the following steps:
a) providing a ceramic catalyst having interconnecting pores with particles of noble metals, such as silver, gold, rhodium and/or palladium on the surface of the interconnecting pores; and
b) grind and sieve the glass particles containing the noble metals.

Yet another embodiment of the present invention comprises a method of making a ceramic catalyst using the following steps:
a) providing a ceramic catalyst having interconnecting pores with particles of metallic silver on the surface of the interconnecting pores; and
b) forming a layer of gold on top of the silver particles.

One embodiment of the present invention is to make a ceramic catalyst comprising a porous silica glass substrate (PG) having substantially interconnecting pores with an average pore size of approximately 2 microns or less, and particles including one or more noble metals on the surface of the substantially interconnecting pores. Particles of noble metals, which may be amorphous and/or crystalline nano-particles, are deposited in the PG. The noble metals may preferably include gold, silver, rhodium and/or palladium. The deposition occurs by introducing a solution of soluble noble metal salts whose concentration of noble metals is given in the Table 1.

The noble metal(s) may be precipitated by the following steps:
a) evaporating the water; and
b) adding chemical that causes precipitation.

The noble metal(s) may be reduced by irradiating with UV light. Other known techniques of reducing the noble metal(s) include addition of a reducing agent such as a soluble compound of Fe⁺². Alternatively, another non-noble metal with multiple oxidation states in one of its lower oxidation state may be used. Non-noble metals that may be used as a reducing agents include iron, tin, chromium, and manganese. Another alternative for the reducing agent is a solution containing NaBH₄ (as used in Example 2 below). Upon reduction of the noble metal(s), the catalyst will turn black as the amorphous and/or crystalline nano-particles become metallic and attach to PG.

The non-noble metal(s) may be removed by the following steps:
a) Perform multiple dry wash cycles with water or chemicals that increase the solubility of non-noble metals, but not the solubility of noble metals (such as HCl), until all the reducing agents have been removed. For example, multiple dry wash cycles may be performed until the concentration of the non-noble metal reducing agents is less than preferably 10% of that of the noble metals, or more preferably 1% of that of the noble metals.
b) Prior, during, or after the above steps, the PG is ground (if necessary) and sieved.

The present invention is also directed to a method of making a ceramic catalyst comprising the steps of:
a. creating a mixture comprising a silicate, a boron, an alkali metal and a noble metal in forms suitable to form a noble metal alkali borosilicate glass;
b. melting the mixture at approximately 1400° C. and 1500° C. to form a viscous solution;
c. cooling the viscous solution without phase separating the viscous solution;
d. heat treating the viscous solution to phase separate the viscous solution into at least a silica rich phase and a silica poor phase comprising a noble metal;
e. cooling the phase separated viscous solution to form a glass; and
f. leaching the silica poor phase comprising a noble metal of the glass to form interconnecting pores in the glass so that at least some of the noble metal remains on the surface of the interconnecting pores.

The noble metal may comprise silver, and may be provided as silver nitrate or silver chloride. The method of making a ceramic catalyst may further comprise the step of exposing the glass to light between and/or during steps e. and/or f. The method may further comprise the step of grinding and sieving the glass prior to the leaching step.

The present invention is also directed to a method of making a ceramic catalyst, comprising the steps of providing raw materials for forming a noble metal alkali borosilicate glass; melting the raw materials at approximately 1200° C.-1500° C. to form a melt; stirring the melt; cooling the melt without phase separation; heat treating the melt for approximately 0.5-24 hours at approximately 500° C.-650° C. to cause phase separation into a silica rich phase and a silica poor phase, wherein the silica poor phase comprises a noble metal; cooling the phase separated melt to approximately room temperature, at which time the melt has become the glass; leaching the silica poor phase of the glass with a leaching agent to form substantially interconnecting pores in the glass so that at least a portion of the noble metal remains on a surface of the interconnecting pores, wherein the leaching agent is not a solvent for the noble metal; reducing the noble metal to a metallic state; and drying the porous glass containing the noble metal. The reducing step may comprise the step of exposing the glass to UV radiation, or the step of adding a reducing agent, wherein the reducing agent may be a non-noble metal. The above method of making a ceramic catalyst may further comprise the step of grinding and sieving the glass prior to the leaching step. The leaching agent used in the leaching step may comprise chloride and/or bromide.

The noble metal in the catalyst may comprise silver, in which case the raw materials for making the catalyst may comprise silver nitrate or silver chloride. In the case the noble metal comprises silver, the method of making a ceramic catalyst may further comprise the step of submerging the porous glass containing metallic silver particles in a solution comprising dissolved gold.

The present invention is also directed to a method of making an efficient high temperature ceramic catalyst, comprising the steps of providing a porous ceramic/silica glass substrate comprising substantially interconnecting pores with an average pore size of approximately 2 microns or less; depositing particles comprising one or more noble metals in the silica glass substrate; precipitating the one or more noble metals; and reducing the one or more noble metals. The first noble metal used in making a ceramic catalyst may be a material selected from the group consisting of silver, gold, rhodium and palladium. The depositing step may comprise the step of introducing a solution of soluble noble metal salts whose concentration of the first noble metal is larger than 0.1 molar solution.

The reducing step may comprise the step of adding a reducing agent, which may comprise a non-noble metal or sodium borohydride. The non-noble metal used as a reducing agent in the reducing step may be iron, tin, chromium, or manganese. Alternatively, the non-noble metal reducing agent may comprise a soluble compound of Fe⁺². Alternatively, the non-noble metal used as a reducing agent is in a lower oxidation state among its multiple oxidation states. The reducing step may also comprise the step of turning the particles to metallic and attaching them to the porous ceramic/silica glass substrate, wherein the particles comprise amorphous and/or crystalline nano-particles. When a non-noble metal is used as a reducing agent, the method of making the catalyst may further comprise the step of washing away the non-noble metal until the concentration of the non-noble metal is smaller than the concentration of the one or more noble metals in the substantially interconnecting pores, preferably approximately less than 10% of the concentration of the one or more noble metals in the substantially interconnecting pores, or more preferably approximately less than 1% of the concentration of the one or more noble metals in the substantially interconnecting pores.

The one or more noble metals may comprise a first noble metal and a second noble metal, wherein the first and the second noble metals are different from each other (e.g., particles comprising the first noble metal being coated on its surface with the second noble metal). The first noble metal may be silver or gold. The second noble metal may be gold, rhodium or palladium.

The average pore size of the catalyst is preferably 1 micron or less, preferably 0.5 microns or less, preferably 0.3 microns or less, preferably 0.2 microns or less, preferably 100 nanometers or less, or preferably 50 nanometers or less.

The size of the porous ceramic/silica glass substrate is preferably 40 mesh (0.420 mm) or less, preferably between 40 mesh (0.420 mm) and 100 mesh (0.149 mm), preferably between 100 mesh (0.149 mm) and 200 mesh (0.074 mm), preferably between 200 mesh (0.074 mm) and 325 mesh (0.044 mm), or preferably less than 325 mesh (0.044 mm).

The average size of each of the noble metal particles in the catalyst is preferably 1 micron or less, preferably 0.5 microns or less, preferably 200 nanometers or less, preferably 100 nanometers or less, or preferably 50 nanometers or less.

The concentration of the first noble metal in the substantially interconnecting pores in the catalyst is equivalent to preferably 0.1 molar solution or greater, preferably 0.2 molar solution or greater, preferably 0.5 molar solution or greater, preferably 1.0 molar solution or greater, or preferably 1.5 molar solution or greater.

Yet another embodiment of the present invention is directed to a method of using the ceramic catalyst made in accordance with the present invention for producing and storing hydrogen for use in generating energy, which involves the following process:
a) reacting a liquid compound capable of producing hydrogen having a formula R₁—XH, with a porous ceramic/silica glass substrate with amorphous and/or crystalline nano-particles of noble metals having the size of less than approximately 1 micron, to produce hydrogen gas and a spent compound comprising (1) R₂—XH, wherein R₂ is dehydrogenated relative to R₁, or (2) R₃═X, wherein R₃ is dehydrogenated relative to R₁, or (3) a combination of (1) and (2);
b) collecting the hydrogen gas; and
c) reacting the spent compound with hydrogen to produce a compound having a formula R₁—XH, thereby regenerating the compound capable of producing hydrogen from the spent compound,
wherein each of R₁, R₂, and R₃ is a moiety independently selected from the group consisting of an alkyl, heteroalkyl, alkenyl, substituted alkenyl, alkynyl, aryl, heteroaryl, alkoxy, cycloalkyl, heterocyclic, alkylaryl, arylalkyl, arylalkenyl, arylalkynyl, arylene, oxyarylene group and combinations thereof, and X is selected from the group consisting of sulfur, oxygen, and selenium.

### DETAILED DESCRIPTION OF PREFERRED EMBODIMENTS

The present invention generally relates to a ceramic catalyst, preferably a high-silica content glass, and a method of making the same. The present invention also generally relates to novel glass compositions and to glass articles, particularly suitable for forming or being converted to ceramic catalysts that can be used and operate at high temperatures, preferably up to approximately 200° C., preferably up to approximately 250° C., preferably up to approximately 300° C., or preferably up to approximately 350° C.

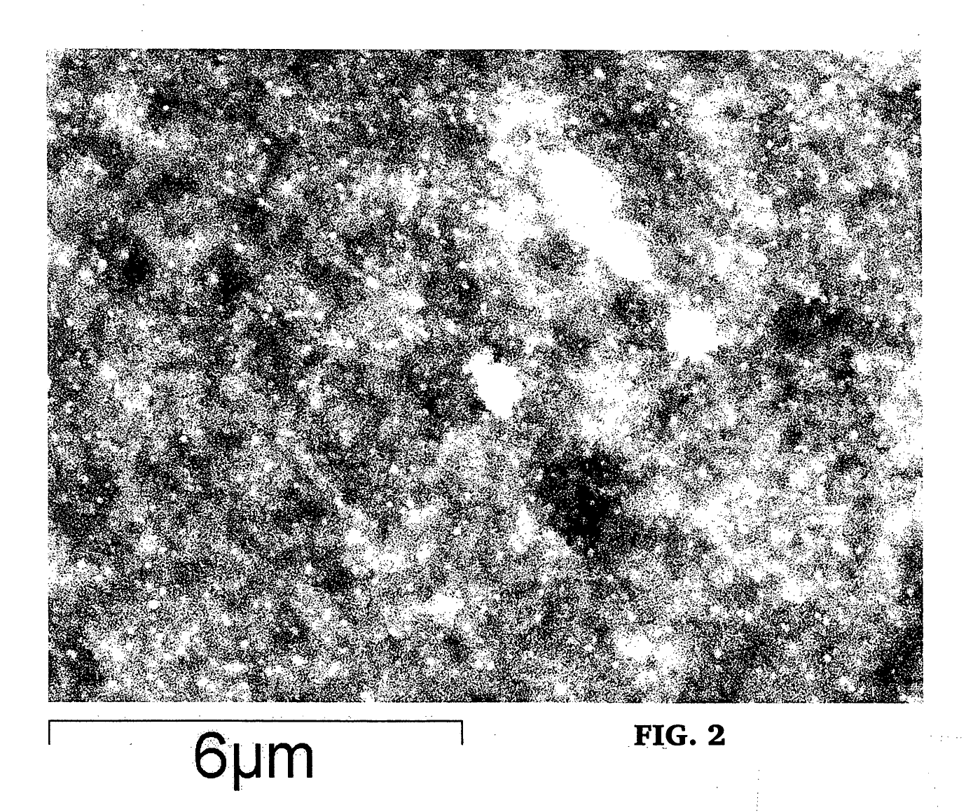

The efficiency of a catalyst depends on the surface area of noble metals. For a given weight of noble metal, the surface area is inversely proportional to the size of the noble metal particle. U.S. Pat. No. 7,185,396 discloses the use of gold particles of 5 microns (5,000 nm). Under the present invention, noble metal particles of 1 micron or less (1,000 nm or less) may be used. FIG. 2 shows the noble metals used in Example 2, which comprise both gold and silver noble metals with an average particle size of 50 nm. This results in a 100 fold increase in surface area for the same molarity of noble metals. One of the objects of the present invention is a catalyst that can efficiently attach and detach hydrogen atoms from organothiol molecules. In his prior U.S. Pat. No. 4,319,905, the contents of which is hereby incorporated by reference in their entirety, Pedro M. Buarque de Macedo disclosed suitable compositions for producing a porous glass substrate with an interconnected structure and a high surface-area-to-volume ratio. However, the porous glass substrate disclosed in U.S. Pat. No. 4,319,905 was used for an optical wave guide, and was not suitable for use as a catalyst. For example, if the molecular stuffing techniques of the prior art were applied to the process disclosed in U.S. Pat. No. 4,319,905 to add a noble metal, such as silver, to catalyze a reaction, the silver present would be ionic (Ag⁺), not metallic (Ag⁰) and the resulting product would not be useful as a catalyst. Thus, what is needed is an improved porous glass substrate, preferably a high-silica content glass, in which silver and/or other noble metals can be added to form a useful catalyst.

In a preferred embodiment of the present invention, the ceramic catalyst is comprised of a ceramic substrate having substantially interconnecting pores, with amorphous and/or crystalline nano-particles of one or more noble metals on a surface of the interconnecting pores. The noble metals form particles that can either be amorphous or crystalline nano-particles, or a mixture of amorphous and crystalline nano-particles. The noble metals may comprise silver, gold, rhodium, or palladium. They comprise preferably silver and gold, wherein the silver particles are coated with a different noble metal, such as gold, rhodium, and/or palladium.

To achieve a satisfactory ceramic substrate having substantially interconnecting pores, it is preferred to choose a phase-separable composition, which, upon heat treatment at a particular temperature, separates into approximately equal volume fractions, and, when held at that temperature, develops a substantially interconnecting structure with a desirable pore size. While every pore does not need to be interconnected, a sufficient percentage of the pores needs to be interconnected to enable fluid, either gas and/or liquid phases, to flow or diffuse in, out of, or through them. The present invention utilizes the method of manufacturing a phase-separable borosilicate glass disclosed in Pedro M Buarque de Macedo's prior U.S. Pat. No. 4,319,905 discussed above, as modified by the teachings discussed herein. Preferred compositions of alkali borosilicate glass as the starting material for such a substrate as set forth in U.S. Pat. No. 4,319,905 include the following ranges of elements in mole % as set forth in Table 1 below:

TABLE 1

| | Broad | Preferred |
|---|---|---|
| SiO₂ | 48-64 | 49.5-59 |
| ₂O₃ | 28-42 | 33-37 |
| R₂O | 4-9 | 6.5-9 |
| Al₂O₃ | 0-3 | 0-2.0 |

### In Table 1, R refers to one or more alkali metals.

In accordance with an embodiment of the present invention, an initial glass composition for the ceramic catalyst may be chosen to have the following characteristics:
The composition can be phase separated into at least two phases including a silica rich phase and a silica poor phase.
The viscosity of the composition is sufficiently high at the coexistence temperature (i.e., the highest temperature at which the composition first phase-separates at equilibrium) that one can cool the glass through the coexistence temperature without phase separation.
The composition is no longer homogenous at a temperature (T_{HT}, heat treatment temperature) below the coexistence temperature. There will be a silica rich phase and a silica poor phase having approximately the same volume.
The silica rich phase and the silica poor phase are substantially interconnected.
The average phase size is approximately 2 microns or less; more preferably approximately 1 microns or less; more preferably approximately 0.5 microns or less, more preferably approximately 0.3 microns or less, more preferably approximately 0.2 microns or less; more preferably approximately 100 nanometers or less; more preferably approximately 50 nanometers or less; or most preferably between 150 and 50 nanometers. The average phase size is measured by, for example, taking a electron micrograph or other similar picture of a cross section of the porous structure, passing a line representing a particular length (e.g., 5 microns) through the picture, counting the number of phase boundaries that the line intersect, and dividing the representative length of the line by the number of intersected phase boundaries to obtain the average phase size. This process can be repeated with one or more additional lines in different directions on the micrograph or other picture to verify or average the results. If the two phases are approximately equal in volume, then the average pore size is equal to the average phase size measured in this way.
The silica poor phase is soluble in an appropriate solvent, and the silica rich phase is not. Upon leaching the phase-separated glass, the silica poor phase is dissolved and thus becomes the pores. The average pore size is approximately the same as the average phase size prior to leaching, since the two phases have approximately the same volume. Therefore, prior to leaching, the average pore size is more aptly defined as the average phase size.
The phase-separated glass is leached at approximately 95° C. in a solution of approximately 1 molar NH₄Cl for the appropriate time, depending on the average particle size.
The newly porous glass is cooled to room temperature and washed with de-ionized water until it is free of chloride, dried at approximately 95° C. and possibly further washed in ammonium hydroxide.
The porous glass is washed again to remove the ammonium and then dried. The glass has an average pore size of approximately 2 microns or less, preferably of approximately 1 micron or less, preferably of approximately 0.5 microns or less, preferably of approximately 0.3 microns or less, preferably of approximately 0.2 microns or less, preferably of approximately 100 nanometers or less, preferably of approximately 50 nanometers or less, or most preferably between 150 and 50 nanometers.
The dried porous glass is placed in a noble metal(s) salt solution, e.g., 0.2 molar (˜1.54 wt %)—1.0 molar (˜7.71 wt %) of HAuCl₄.
The sample is dried at approximately 35° C.
The sample is placed in a solution containing a reducing agent, such as Fe²⁺ compound that reduces the noble metal(s) to a metallic state.
The glass will turn black upon reduction of the noble metal(s).
The porous glass is washed free of the element used to reduce the noble metal(s), i.e., non-noble metal Fe.
The catalyst is ground and sieved to the appropriate mesh size, i.e., 100-200 mesh (0.149 mm-0.074 mm).

The porous ceramic/silica glass substrate has an average pore size of approximately 2 microns or less, preferably of approximately 1 micron or less, preferably of approximately 0.5 microns or less, preferably of approximately 0.3 microns or less, preferably of approximately 0.2 microns or less, preferably of approximately 100 nanometers or less, preferably of approximately 50 nanometers or less, or most preferably between 150 and 50 nanometers.

The ceramic catalyst will have an average particle size of approximately 40 mesh (0.420 mm) or less, preferably between 40 mesh (0.420 mm) and 100 mesh (0.149 mm), preferably between 100 mesh (0.149 mm) and 200 mesh (0.074 mm), or preferably between 200 mesh (0.074 mm) and 325 mesh (0.044 mm). Under the present invention, the ceramic catalyst is preferably manufactured from a glass composition comprising a noble metal alkali borosilicate glass, which simultaneously addresses problems associated with prior art ceramic catalysts. In accordance with an embodiment of the present invention, an initial glass composition for the ceramic catalyst may be chosen to have the following characteristics:
The composition can be phase separated into at least two phases including a silica rich phase and a silica poor phase.
The viscosity of the composition is sufficiently high at the coexistence temperature (i.e., the highest temperature at which the composition first phase separates at equilibrium) that one can cool the glass through the coexistence temperature without phase separation.
The composition is no longer homogenous at a temperature (T_{HT}, heat treatment temperature) below the coexistence temperature. There will be a silica rich phase and a silica poor phase having approximately the same volume.
The silica rich phase and the silica poor phase are substantially interconnected.
The average phase size is approximately 2 microns or less; more preferably approximately 1 microns or less; more preferably approximately 0.5 microns or less, more preferably approximately 0.3 microns or less, more preferably approximately 0.2 microns or less; more preferably approximately 100 nanometers or less, more preferably approximately 50 nanometers or less, or most preferably between 150 and 50 nanometers. The average phase size is measured by, for example, taking a electron micrograph or other similar picture of a cross section of the porous structure, passing a line representing a particular length (e.g., 5 microns) through the picture, counting the number of phase boundaries that the line intersect, and dividing the representative length of the line by the number of intersected phase boundaries to obtain the average phase size. This process can be repeated with one or more additional lines in different directions on the micrograph or other picture to verify or average the results.
The silica poor phase is soluble in an appropriate solvent, and the silica rich phase is not. Upon leaching the phase-separated glass, the silica poor phase is dissolved and thus becomes the pores. The average pore size is approximately the same as the average phase size prior to leaching, since the two phases have approximately the same volume. Therefore, prior to leaching, the average pore size is more aptly defined as the average phase size.

Another embodiment of the present invention has found a way of using the large surface areas available from the leached phase-separated glasses to become useful catalysts, by attaching monovalent (or divalent) noble metal with amorphous and/or crystalline nano-particles comprised of one or more noble metals. Prior art techniques of doping leached phase-separated glasses to add noble metal atoms on the interconnected surface areas are not practical or economically feasible to form amorphous and/or crystalline nano-particles comprised of one or more noble metals on the interconnected surface areas, as noted above. The present invention solves this problem by dissolving one or more noble metals in the molten glass at the beginning of the formation process and phase separation. This can be achieved by modifying the composition of the alkali borosilicate glass to include the following ranges of elements in mole % as set forth in Table 2 below:

TABLE 2

| | Broad | Preferred |
|---|---|---|
| SiO₂ | 48-64 | 49.5-59 |
| B₂O₃ | 28-42 | 33-37 |
| R₂O | 4-9 | 5-8 |
| Al₂O₃ | 0-3 | 0-2.0 |
| MₓO_{y} | 1-4 | 1.5-2.5 |

In Table 2, R refers to one or more alkali metals, M refers one or more noble metals, and x and y are respectively selected based on the appropriate valence of the selected noble metals. Typically x varies between approximately 1 and approximately 2, and y varies between approximately 1 and approximately 5. Examples of alkali metals that can be used as R include lithium, sodium, potassium, rubidium, and cesium. In a preferred embodiment, sodium and/or potassium are used. Examples of noble metals that can be used as M include silver, rhodium, palladium, and iridium. In a preferred embodiment, silver is used, in which case x is approximately 2 and y is approximately 1. In another embodiment, rhodium may also be used in conjunction with or instead of silver, in which case x and y for the rhodium compound are approximately 1.

In one embodiment of the present invention, silver is chosen to be one of the noble metals used to form the majority of the weight and/or volume of the amorphous and/or crystalline nano-particles. A ceramic catalyst having amorphous and/or crystalline nano-particles including silver can be formed in accordance with an embodiment of the present invention by the following process:
a) Raw materials are selected and weighed in accordance with the recipes set forth in Table 2 above, wherein the alkali metals are carbonates and noble metal is silver to form a composition of silver alkai borosilicate. For example, an appropriate composition would include 56% SiO₂, 36% B₂O₃, 3% Na₂O, 3% K₂O, 2% Ag₂O. Ag₂O may be also be first introduced into the composition by using, e.g., AgNO₃ or AgCl.
b) Melt the raw materials at a temperature above the coexistence temperature, e.g., approximately between 1,200° C. and 1,500° C., in, e.g., a platinum crucible to form a melt. Stir the melt appropriately while melting.
c) The melt is cooled quickly to room temperature without phase separation, at which time a homogeneous glass has been formed.
d) The glass is ground and sieved preferably so it passes 100 mesh (0.149 mm) and does not pass 200 mesh (0.074 mm).
e) Apply heat treatment to the glass powders for approximately 0.5-24 hours at approximately 500° C.-650° C. (e.g., at approximately 550° C. for 1.5 hours) to cause phase separation. Silver should accumulate in the silica poor phase, effectively doubling its concentration from the starting composition.
f) Cool the phase-separated glass to approximately room temperature.
g) Leach the glass in solution comprising HCl at approximately 95° C.
h) Reducing the silver to a metallic state can be accomplished by the use of either UV radiation or a reducing agent, such as Fe²⁺ compound. After the silver is reduced, the glass turns black, an indication that the silver has precipitated as metallic colloid and/or nanocrystal.
i) The glass is washed with de-ionized water.
j) The glass is dried.

By following this process, a ceramic catalyst having substantially interconnecting pores with a large surface area, and metallic amorphous and/or crystalline nano-particles of silver on the surface of the interconnecting pores is formed.

In yet another embodiment of the present invention, a layer of a second noble metal, such as gold, may be formed on the surface of a first noble metal, such as silver, which is sitting on the surface of the interconnecting pores of the ceramic catalyst.

An example of a ceramic catalyst in accordance with this embodiment of the present invention can be made as follows:
a) A ceramic catalyst having interconnecting pores with amorphous and/or crystalline nano-particles including silver (and/or another noble metal) on the surface of the interconnecting pores is provided, such as the one described above.
b) Submerge the ceramic catalyst into a solution containing gold, such as a solution comprising HAu(NO₃)₄ in HNO₃ acid, or HAuCl₄ in ammonia.
c) Continue to submerge the ceramic catalyst until the concentration of gold in the solution substantially stops decreasing and the silver concentration in solution substantially stops increasing. It may be necessary to replenish the solution if the gold concentration decreases too much.
d) The glass is washed with de-ionized water.
e) The glass is dried.

By following this process, a ceramic catalyst having substantially interconnecting pores with a large surface area, and amorphous and/or crystalline nano-particles including silver on the surface of the interconnecting pores is formed, with a second noble metal metallic layer of, for instance, gold, coating the surface of the silver particles.

Furthermore, the present invention provides a ceramic catalyst capable of operating at temperatures higher than 200° C. to detach the hydrogen atoms, which become hydrogen gas, from organothiol molecules as described in U.S. Pat. No. 7,186,396, the contents of which have been incorporated herein by reference in their entirety. The catalyst in U.S. Pat. No. 7,186,396 uses gold particles with the size of 5 microns. As the micrograph in FIG. 2 shows, the catalyst made in accordance with an embodiment of the present invention described in Example 2 below has gold and silver particles with a size of about 50 nm (0.05 microns). The ability to get such small particle size is due to the porous ceramic/silica glass substrate preventing the noble metal particles from agglomerating. This smaller particle size gives the surface area for the same mass of noble metals that is hundred times greater than that of the particles disclosed in U.S. Pat. No. 7,186,396, thus greatly increasing the catalyst performance for given mass of noble metals. The ceramic catalyst made in accordance with the present invention can be used to release hydrogen from the organothiol molecules (e.g., in response to a need to use the hydrogen as a fuel) and to attach new hydrogen on these depleted organothiol molecules where one wants to store the hydrogen.

Accordingly, another embodiment of the present invention may be directed to a method of using the ceramic catalyst made in accordance with the present invention for producing and storing hydrogen for use in generating energy, which involves the following process:
a) reacting a liquid compound capable of producing hydrogen having a formula R₁—XH, with a porous ceramic/silica glass substrate with amorphous and/or crystalline nano-particles of noble metals having the size of less than approximately 1 micron, to produce hydrogen gas and a spent compound comprising (1) R₂—XH, wherein R₂ is dehydrogenated relative to R₁, or (2) R₃═X, wherein R₃ is dehydrogenated relative to R₁, or (3) a combination of (1) and (2);
b) collecting the hydrogen gas; and
c) reacting the spent compound with hydrogen to produce a compound having a formula R₁—XH, thereby regenerating the compound capable of producing hydrogen from the spent compound,
wherein each of R₁, R₂, and R₃ is a moiety independently selected from the group consisting of an alkyl, heteroalkyl, alkenyl, substituted alkenyl, alkynyl, aryl, heteroaryl, alkoxy, cycloalkyl, heterocyclic, alkylaryl, arylalkyl, arylalkenyl, arylalkynyl, arylene, oxyarylene group and combinations thereof, and X is selected from the group consisting of sulfur, oxygen, and selenium.

This method addresses the problem of U.S. Pat. No. 7,185,396 noted above by providing an efficient catalyst to detach the hydrogen from the orgaothiol so that the hydrogen can be used to generate energy and to attach to the depleted organothiol molecules at the hydrogen source.

The following examples provide the details of exemplary processes and compositions for preparing the ceramic catalyst in accordance with the present invention.

### EXAMPLE 1

Details of the process to prepare the ceramic catalyst:
a) The raw materials are weighed according to Table 3 below and mixed.

TABLE 3

| | WT g | MOLES % |
|---|---|---|
| SiO₂ | 101.30 | 54.94 |
| B₂O₃ | 60.19 | 36.79 |
| Na₂O | 8.22 | 4.32 |
| K₂O | 11.40 | 3.95 |

b) The mixed raw materials are placed in a crucible/furnace at a temperature of approximately 1,250° C., and stirred for 4 hours.
c) The glass is cooled to room temperature without phase separation by pouring it onto a metal plate.
d) Heat treat the uniform glass for approximately 4 hours at approximately 575° C. to cause phase separation.
e) Leach each 3 g of phase-separated glass in 100 ml 1 molar NH₄Cl at 95° C. for 3 days.
f) Cool to room temperature.
g) Wash the porous glass (PG) with water until free of Cl.
h) Dry the PG at 95° C. for at least 30 minutes.
i) Wash the PG with approximately 1 molar of NH₄OH.
j) Wash with water until substantially no smell of NH₃ remains.
k) Dry the PG preferably at a low temperature, e.g., 35° C.
l) Soak the PG in noble metal(s) salt solution, e.g. HAuCl₄ (0.2 molar).
m) Dry the PG preferably at 35° C.
n) Use Fe²⁺ compound as a reducing agent that reduces the noble metal to the metallic state.
o) The PG will turn black upon reduction of noble metal.
p) Wash the PG until free of the element used to reduce noble metal, i.e., the non-noble metal Fe.
q) Dry the PG preferably at 35° C.
r) The catalyst is ground and sieved into two fractions—(1) 40 mesh-100 mesh and (2) 100 mesh −200 mesh.
s) The ceramic catalyst is ready.

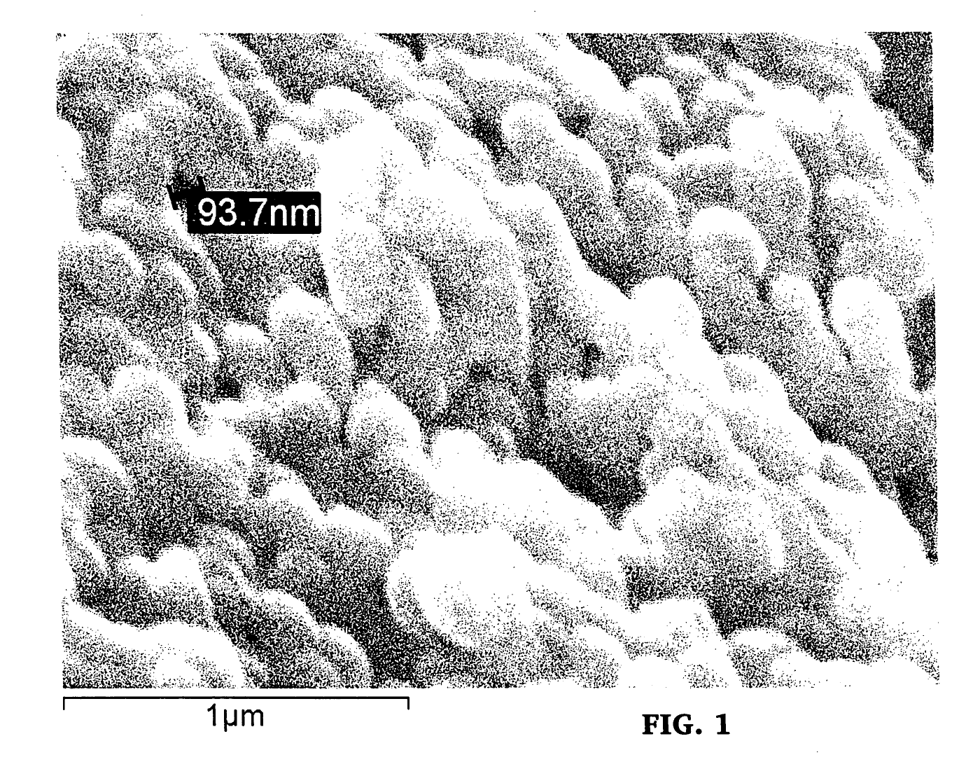

FIG. 1 shows the pores of a ceramic glass substrate prepared under the similar processes as Example 1 described above, which were observed with a scanning electronic microscope (SEM). After Step (d) of Example 1, the glass shown in FIG. 1 was leached with HF, rather than being leached in accordance with Step (e) described above. This alternative method of leaching was used to help the SEM to take a more vivid image. However, for the purpose of improving the performance of the catalyst, this method is not as good as Step (e) of Example 1 described above. As indicated by the black scale mark in FIG. 1, the size of a pore is measured to be 93.7 mm.

### EXAMPLE 2

Details of the process to prepare the ceramic catalyst:
a) The raw materials are weighed according to Table 3 from Example 1 and mixed.
b) The mixed raw materials are placed in a crucible/furnace at a temperature of approximately 1,250° C., and stirred for 4 hours.
c) The glass is cooled to room temperature without phase separation by pouring it onto a metal plate.
d) Heat treat the uniform glass for approximately 4 hours at approximately 575° C. to cause phase separation.
e) Leach each 3 g of phase-separated glass in 100 ml 1 molar NH₄Cl at 95° C. for 3 days.
f) Cool to room temperature.
g) Wash porous glass (PG) with water until free of Cl.
h) Dry the PG at 95° C. for at least 30 minutes.
i) Wash the PG with approximately 1 molar of NH₄OH.
j) Wash with water until substantially no smell of NH₃ remains.
k) Dry the PG preferably at a low temperature, e.g., 35° C.
l) Soak the PG in 1 molar NH₄OH.
m) Dry the PG.
n) Soak the PG in 0.1 molar AgNO₃.
o) Rinse the PG several times in water containing NaCl.
p) Rinse for an additional 90 minutes in heated water to expedite the release of non-ion exchanged Ag⁺ in the pores.
q) Rinse in cold water containing NaCl, until the Ag⁺ cannot be detected in the solution.
r) Dry the PG.
s) Prepare a reducing solution of 2 mg NaBH₄ and concentrated NH₄OH to slowly reduce the Ag⁺.
t) Expose the PG to drops of the reducing solution, causing the PG to turn black when the Ag is reduced.
u) Rinse the PG several times in water.
v) Dry the PG.
w) Soak the PG in 0.2 molar HAuCl₄.
x) Heat to 70° C. for approximately 10 minutes.
y) Rinse the PG in water several times over the course of several hours.
z) Dry the PG at 90° C.

FIG. 2 shows the noble metals in the ceramic catalyst of Example 2, including both gold and silver. The majority of the metal particles were observed to be about 50 nm in diameter.

### EXAMPLE 3

Details of the process to prepare the ceramic catalyst:
a) Appropriate raw materials are selected and weighed to form a composition of silver alkali borosilicate, wherein the alkali metals are carbonates and noble metal is silver. For example, an appropriate composition would include 56% SiO₂, 36% B₂O₃, 3% Na₂O, 3% K₂O, 2% Ag₂O. Ag₂O may be also be first introduced into the composition by using, e.g., AgCl.
b) The mixed raw materials are placed in a crucible/furnace at a temperature of approximately 1,250° C. to form a melt, and stirred for 4 hours.
c) The melt is cooled to room temperature without phase separation by pouring it onto a metal plate, at which time the melt has become a uniform glass.
d) Heat treat the uniform glass for approximately 1.5 hours at approximately 550° C. to cause phase separation.
e) Cool the phase-separated glass to approximately room temperature.
f) The silica poor phase now contains most of the Ag.
g) Leach with HCl at approximately 95° C. for the suitable leaching time. Leaching time depends on the glass particle size.
h) Wash porous glass (PG) with de-ionized water until all Cl is removed.
i) The PG is dried.
j) Use Fe²⁺ compound as a reducing agent that reduces the noble metal to the metallic state.
k) The PG will turn black upon reduction of noble metal.
l) Wash the PG until it is free of the element used to reduce the noble metal, i.e., the non-noble metal Fe.
m) Dry the PG preferably at 35° C.
n) Submerge the ceramic catalyst into a solution containing gold, such as a solution comprising HAu(NO₃)₄ in H NO₃ acid.
o) Continue to submerge the ceramic catalyst until the concentration of gold in the solution substantially stops decreasing and the silver concentration in the solution substantially stops increasing. It may be necessary to replenish the solution if the gold concentration decreases too much.
p) The PG is washed with deionized water.
q) The PG is dried.
r) The catalyst is ground and sieved into two fractions—(1) 40 mesh-100 mesh and (2) 100 mesh −200 mesh.
s) The ceramic catalyst is ready.

### EXAMPLE 4

Details of hydrogen production following the reaction of an organothiol with a ceramic catalyst substrate having amorphous and/or crystalline noble metal nano-particles are described as follows:
a) Provide the ceramic catalyst as prepared in Example 1, wherein the noble metal is gold, with a substrate particle size between approximately 100-200 mesh (0.149-0.074 nm).
b) The catalyst is activated by heating it in a flow of oxygen followed by hydrogen at 280° C.
c) The catalyst is tested by flowing a gas containing Hydmol, C₅H₁₁—SH at a temperature of 250° C. This test was conducted in an experiment at Asemblon, Inc.
d) The experimental results reported that 38.92% of the Hydmol became 2 methylthiophene, C₅H₆—S and liberated 3 molecules of H₂.

Thus, as a first test, it produced very successful results. The reaction can be further optimized by adjusting parameters such as reaction temperature, gas pressure, amount and type of noble metals in the catalyst, etc. Thus, this result shows that the catalyst made in accordance with the present invention can be used for the storing and producing hydrogen for use in generating energy.

Now that the preferred embodiments of the present invention have been shown and described in detail, various modifications and improvements thereon will become readily apparent to those skilled in the art. For example, the same procedure can be done with other noble metals, such as, rhodium nitrate which is also soluble. For high temperature applications rhodium may be the preferred noble metal, even though it is much more expensive than gold. Accordingly, the spirit and scope of the present invention is to be construed broadly and limited only by the appended claims and not by the foregoing specification.

What is claimed is:

1. A noble metal alkali borosilicate glass composition comprising by mole percent: 48-64 SiO₂, 28-42 B₂O₃, 4-9 R₂O, 0-3 Al₂O₃, and 1-4 MₓO_{y}, wherein R refers to one or more alkali metals, M refers to one or more noble metals, x varies between approximately 1 and approximately 2, and y varies between approximately 1 and approximately 2.

2. The noble metal alkali borosilicate glass composition of claim 1, wherein the one or more alkali metals are one or more materials selected from the group consisting of lithium, sodium, potassium, rubidium and cesium.

3. The noble metal alkali borosilicate glass composition of claim 1, wherein the one or more noble metals are one or more materials selected from the group consisting of silver and rhodium.

4. The noble metal alkali borosilicate glass composition of claim 1, wherein the one or more noble metals comprise silver, x is approximately 2 and y is approximately 1.

5. The noble metal alkali borosilicate glass composition of claim 1, wherein the one or more noble metals comprise rhodium.
